(19) United States
(12) Patent Application Publication
(10) Pub. No.: US 2016/0092955 A1
(43) Pub. Date: Mar. 31, 2016

(54) METHODS AND SYSTEMS FOR RECOGNITION OF IN-STORE CUSTOMERS

(71) Applicant: Wal-Mart Stores, Inc., Bentonville, AR (US)

(72) Inventors: Srikannan Gopalsamy, Foster City, CA (US); Vasu Palanisamy, Union City, CA (US); Chandrasekar Ramalingam, Union City, CA (US); Shanmuga Sundaram Sowndara Rajan, Fremont, CA (US); Dharani Prasad Pannam, Foster City, CA (US)

(21) Appl. No.: 14/502,865

(22) Filed: Sep. 30, 2014

(51) Int. Cl. G06Q 30/06

(52) U.S. Cl. CPC G06Q 30/0613

(57) ABSTRACT

Various examples of methods and systems for recognition of in-store customers are described. In one implementation, a method may receive first information related to identification of a first customer prior to the first customer visiting a store. The method may also receive second information related to identification of a second customer when the second customer visits the store. The method may further determine whether the second customer is the first customer based on the first information and the second information. The method may additionally provide the first information related to identification of the first customer to one or more computing devices in response to a positive determination that the second customer is the first customer.

### TECHNICAL FIELD

The present disclosure relates to methods and systems for recognition of in-store customers.

### BACKGROUND

Achieving and maintaining high customer satisfaction is often sought after by merchants, vendors and business alike. One way to enhance customer satisfaction is providing a personalized shopping experience to the customers. However, in order to provide a personalized shopping experience to a given customer, a store needs to recognize the customer when the customer visits the store.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting an example computing environment within which example embodiments of recognition of in-store customers of the present disclosure may be implemented.

FIG. 2 is a block diagram depicting an embodiment of an apparatus configured to implement example embodiments of recognition of in-store customers of the present disclosure.

FIG. 3 is a flowchart diagram of an embodiment of a process related to recognition of in-store customers in accordance with an embodiment of the present disclosure.

FIG. 4 is a flowchart diagram of an embodiment of a process related to recognition of in-store customers in accordance with another embodiment of the present disclosure.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

The articles “a” and “an” are used herein to refer to one or to more than one (i.e. to at least one) of the grammatical object of the article. By way of example, “a user” means one user or more than one users. Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

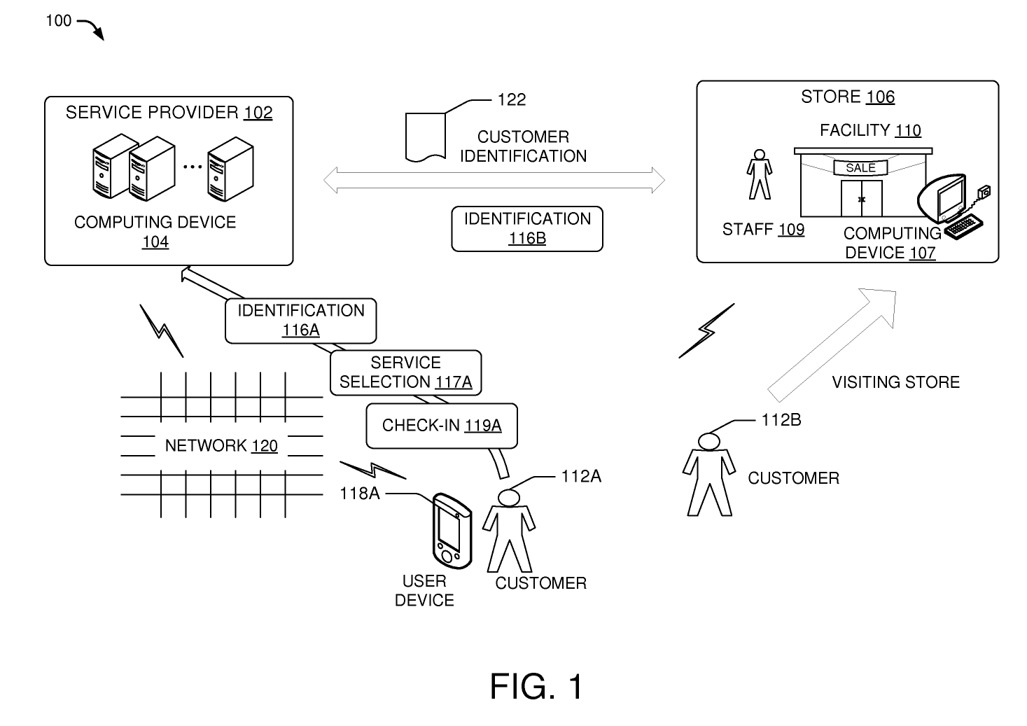

FIG. 1 is a block diagram depicting an example computing environment 100 within which an example embodiment of the present disclosure may be implemented. Computing environment 100 includes a computing device 104, e.g., server, associated with a service provider 102. Service provider 102 may provide a service related to recognition of in-store customer, e.g., at a store 106. For example, the service may include a set of related software and/or hardware functionalities that, together with certain policies set by service provider 102, enable staff 109 associated with a facility 110 of the store 106 to recognize in-store customers when they arrive at the store 106 for store services.

In some embodiments, computing device 104 may receive first information related to identification of a first customer prior to the first customer visiting store 106. For example, prior to a customer 112A visiting store 106, computing device 104 may receive an identification 116A of customer 112A from a user device 118A, which is operated by or otherwise associated with customer 112A. In one implementation, customer 112A may upload one or more photographs of him/herself when checking in for one or more store services at store 106 such as, for example, in-store pickup, return of merchandise, exchanges and/or one or more other customer services. Alternatively, in lieu of or in addition to uploading on or more photographs of him/herself, customer 112A may upload vehicle registration number, e.g., license plate number, of a vehicle operated by or otherwise associated with customer 112A, e.g., a vehicle driven by customer 112A for one or more drive-through services. Computing device 104 may also receive an indication of a selected in-store service from the first customer. For example, computing device 104 may receive a service selection 117A from user device 118A.

Computing device may further receive second information related to identification of a second customer when the second customer visits the store. For example, when a customer 112B visits store 106, computing device 104 may receive an identification 116B of customer 112B from store 106, e.g., an image of customer 112B or license plate of a vehicle operated by customer 112B captured by a camera at store 106. Computing device 104 may determine whether the second customer is the first customer based on the first information and the second information. For example, computing device 104 may compare identification 116A and identification 116B to determine whether customer 112B is the same person as customer 112A. In response to a positive determination that that the second customer is the first customer, computing device 104 may provide the first information related to identification of the first customer to one or more second computing devices. For example, in the event of a positive determination that customer 112B is indeed the same person as customer 112A, computing device 104 may provide, e.g., transmit, a customer identification 122 (which includes identification 116A of customer 112A) to one or more computing devices, e.g., a computing device 107 associated with facility 110 of store 106 and operated by staff 109 of store 106. Upon receiving identification 116A of customer 112A, e.g., a photograph or vehicle license plate number, staff 109, e.g., store associate(s) of store 106, may be able to recognize customer 112A or his/her vehicle when customer 112A arrives at store 106 and provide personalized shopping experience to customer 112A. The same can be done to some or all other customers who visit store 106.

In some embodiments, computing device 104 may receive data and/or information related to customer 112A from user device 118A via a network 120. Network 120 enables computing device 104 to exchange information with user device 118. Network 120 may include wired and/or wireless networks that enable communications between the various computing devices described in environment 100. In some embodiments, network 120 may include local area networks (LANs), wide area networks (WAN), mobile telephone networks (MTNs), and other types of networks, possibly used in conjunction with one another, to facilitate communication between the various computing devices (e.g., computing device 104 and user device 118). User device 118 may be a mobile or desktop computer, a personal data assistant (PDA), an internet appliance, an internet enabled mobile phone, a server or any other computing device configured with a network connection.

In some embodiments, computing device 104 may receive the first information when the first customer provides a notification of an intention to visit the store. For example, computing device 104 may receive identification 116A from user device 118A when customer 112A checks in by sending a check-in notification 119a via user device 118A to indicate an intention to visit store 106.

In some embodiments, computing device 104 may receive the first information from a database upon receiving a notification from the first customer of an intention to visit the store. For example, computing device 104 may retrieve identification 116A from a database (not shown) upon receiving check-in notification 119a via user device 118A to indicate an intention to visit store 106.

In some embodiments, the first information related to identification of the first customer may include a photograph of the first customer or a vehicle registration number of a vehicle associated with the first customer. For example, identification 116A may include one or more photographs of customer 112A and/or a license plate number of each vehicle operated by or otherwise associated with customer 112A.

In some embodiments, the second information related to identification of the second customer may include a photograph of the second customer or a vehicle registration number of a vehicle associated with the second customer. For example, identification 116B may include one or more photographs of customer 112B and/or a license plate number of each vehicle operated by or otherwise associated with customer 112B.

In some embodiments, the first information related to identification of the first customer and the second information related to identification of the second customer are of a same type. For example, if identification 116A includes a photograph of customer 112A then a photograph of customer 112B is used in the comparison by computing device 104. Likewise, if identification 116A includes a vehicle registration number of a vehicle operated by or otherwise associated with customer 112A then a vehicle registration number of a vehicle operated by or otherwise associated with customer 112B is also used in the comparison by computing device 104.

In some embodiments, computing device 104 may also receive, from the first customer, an indication of a selected in-store service. For example, computing device 104 may receive service selection 117A from user device 118A of customer 112A to indicate a selected in-store service for which customer 112A is visiting store 106. Accordingly, computing device 104 may associate the first information related to identification of the first customer to the selected in-store service in response to the positive determination that the second customer is the first customer. For example, computing device 104 may associate identification 116A of customer 112A to the selected in-store service in response to the positive determination that customer 112B is indeed the same person as customer 112A.

Thus, the proposed scheme enables store associates to recognize the customers as they arrive at the store for store services. With the recognition, store associates can provide personalized shopping experience to the customers such as, for example, greeting each recognized customer by name and recommending one or more products and/or services that may be of interest to the recognized customer. This likely would not only enhance customer satisfaction and loyalty, but also help increase store revenue and profit.

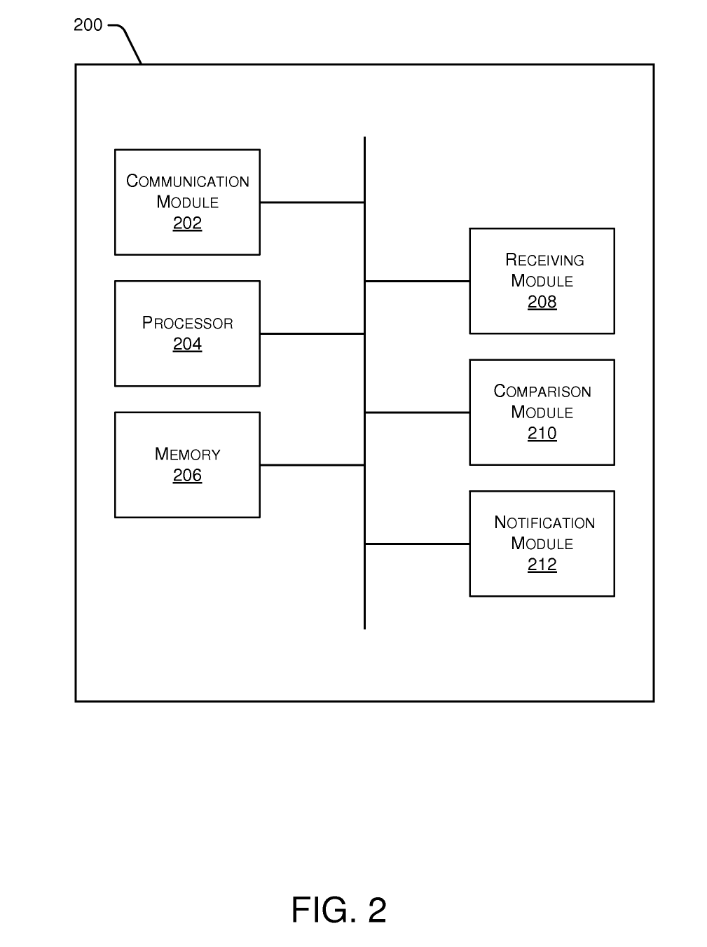

FIG. 2 is a block diagram depicting an embodiment of a computing device 200 configured to implement systems and methods of the present disclosure. Computing device 200 (e.g., computing device 104) performs various functions related to recognition of in-store customers, as discussed herein. In some embodiments, computing device 200 may be implemented as one or more computing devices that cooperatively implement the functions described herein. Computing device 200 may include a communication module 202, one or more processors (shown as a processor 204 in FIG. 2), and a memory 206. Communication module 202 allows computing device 200 to communicate with other systems, such as communication networks, other servers, etc. Processor 204 executes one or more sets of instructions to implement the functionality provided by computing device 200. Memory 206 stores the one or more sets of instructions executable by processor 204 as well as other data used by processor 204. Computing device 200 may also include a receiving module 208, a comparison module 210, and a notification module 212. Although the receiving module 208, comparison module 210 and notification module 212 are depicted as discrete modules separate from the processor 204, in various implementations one or more of the receiving module 208, comparison module 210 and notification module 212 may be part of the processor 204.

Receiving module 208 may be configured to receive first information related to identification of a first customer prior to the first customer visiting a store. For example, receiving module 208 may receive identification 116A of customer 112A from user device 118A prior to customer 112A visiting store 106.

Receiving module 208 may also be configured to receive second information related to identification of a second customer when the second customer visits the store. For example, receiving module 208 may receive identification 116B of customer 112B, e.g., form a camera of store 106, when customer 112B arrives at store 106.

Comparison module 210 may be configured to compare the first information and the second information to determine whether the second customer is the first customer. For example, comparison module 210 may compare identification 116A and identification 116B to determine whether customer 112B is indeed the same person as customer 112A.

Notification module 212 may be configured to provide the first information related to identification of the first customer to one or more computing devices in response to a positive determination that the second customer is the first customer. For example, notification module 212 may provide, e.g., transmit, identification 116A to computing device 107 in the event of a positive determination that customer 112B is customer 112A.

In some embodiments, receiving module 208 may be configured to receive the first information when the first customer provides a notification of an intention to visit the store. For example, receiving module 208 may receive identification 116A from user device 118A when customer 112A checks in by sending check-in notification 119a via user device 118A to indicate an intention to visit store 106.

In some embodiments, receiving module 208 may be configured to receive the first information related to identification of the first customer comprises retrieving the first information from a database upon receiving a notification from the first customer of an intention to visit the store. For example, receiving module 208 may retrieve identification 116A from a database (not shown) upon receiving check-in notification 119a via user device 118A to indicate an intention to visit store 106.

In some embodiments, the first information related to identification of the first customer may include a photograph of the first customer or a vehicle registration number of a vehicle associated with the first customer. For example, identification 116A may include one or more photographs of customer 112A and/or a license plate number of each vehicle operated by or otherwise associated with customer 112A.

In some embodiments, the second information related to identification of the second customer may include a photograph of the second customer or a vehicle registration number of a vehicle associated with the second customer. For example, identification 116B may include one or more photographs of customer 112B and/or a license plate number of each vehicle operated by or otherwise associated with customer 112B.

In some embodiments, the first information related to identification of the first customer and the second information related to identification of the second customer are of a same type. For example, if identification 116A includes a photograph of customer 112A then a photograph of customer 112B is used in the comparison by comparison module 210. Likewise, if identification 116A includes a vehicle registration number of a vehicle operated by or otherwise associated with customer 112A then a vehicle registration number of a vehicle operated by or otherwise associated with customer 112B is also used in the comparison by comparison module 210.

In some embodiments, receiving module 208 may also be configured to receive, from the first customer, an indication of a selected in-store service. For example, receiving module 208 may receive service selection 117A from user device 118A of customer 112A to indicate a selected in-store service for which customer 112A is visiting store 106. Accordingly, processor 204 may associate the first information related to identification of the first customer to the selected in-store service in response to the positive determination that the second customer is the first customer. For example, processor 204 may associate identification 116A of customer 112A to the selected in-store service in response to the positive determination that customer 112B is indeed the same person as customer 112A.

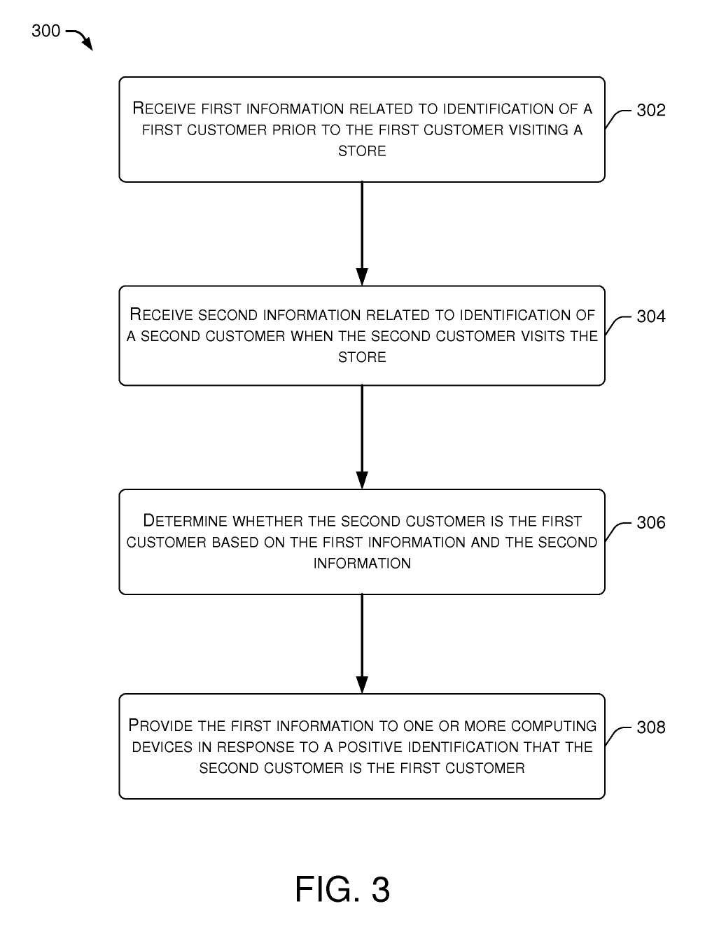

FIG. 3 is a flowchart diagram of an embodiment of a process 300 for recognition of in-store customers in accordance with an embodiment of the present disclosure. Example process 300 includes one or more operations, actions, or functions. Although illustrated as discrete blocks, various blocks may be divided into additional blocks, combined into fewer blocks, or eliminated, depending on the desired implementation. Process 300 may be implemented by one or more processors including, for example, computing device 200. For illustrative purposes, the operations described below are performed by one or more processors of computing device 104 as shown in FIG. 1 and/or processor 204 of computing device 200 as shown in FIG. 2.

At 302, one or more processors of computing device 104 may receive first information related to identification of a first customer prior to the first customer visiting a store.

At 304, the one or more processors of computing device 104 may receive second information related to identification of a second customer when the second customer visits the store.

At 306, the one or more processors of computing device 104 may determine whether the second customer is the first customer based on the first information and the second information.

At 308, the one or more processors of computing device 104 may provide the first information related to identification of the first customer to one or more second computing devices in response to a positive determination that the second customer is the first customer.

In some embodiments, in receiving the first information related to identification of the first customer, process 300 may receive the first information when the first customer provides a notification of an intention to visit the store.

In some embodiments, in receiving the first information related to identification of the first customer, process 300 may retrieve the first information from a database upon receiving a notification from the first customer of an intention to visit the store.

In some embodiments, the first information related to identification of the first customer may include a photograph of the first customer. Alternatively, the first information related to identification of the first customer may include a vehicle registration number of a vehicle associated with the first customer.

In some embodiments, the second information related to identification of the second customer may include a photograph of the second customer. Alternatively, the second information related to identification of the second customer may include a vehicle registration number of a vehicle associated with the second customer.

In some embodiments, the first information related to identification of the first customer and the second information related to identification of the second customer may be of a same type. For example, if a photograph of the first customer is used then a photograph of the second customer is used in the comparison. Likewise, if a vehicle registration number of a vehicle associated with the first customer is used then a vehicle registration number of a vehicle associated with the second customer is also used.

In some embodiments, process 300 may also include receiving, from the first customer, an indication of a selected in-store service. Process 300 may further include associating the first information related to identification of the first customer to the selected in-store service in response to the positive determination that the second customer is the first customer.

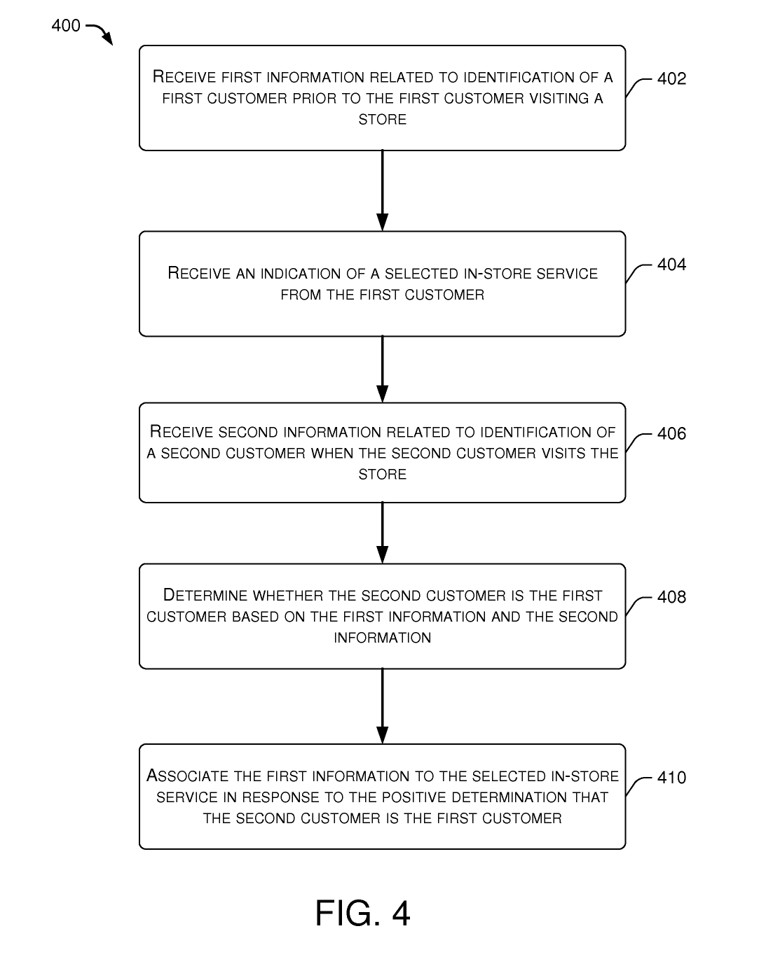

FIG. 4 is a flowchart diagram of an embodiment of a process 400 for recognition of in-store customers in accordance with an embodiment of the present disclosure. Example process 400 includes one or more operations, actions, or functions. Although illustrated as discrete blocks, various blocks may be divided into additional blocks, combined into fewer blocks, or eliminated, depending on the desired implementation. Process 400 may be implemented by one or more processors including, for example, computing device 200. For illustrative purposes, the operations described below are performed by one or more processors of computing device 104 as shown in FIG. 1 and/or processor 204 of computing device 200 as shown in FIG. 2.

At 402, one or more processors of computing device 104 may receive first information related to identification of a first customer prior to the first customer visiting a store.

At 404, the one or more processors of computing device 104 may receive, from the first customer, an indication of a selected in-store service.

At 406, the one or more processors of computing device 104 may receive second information related to identification of a second customer when the second customer visits the store.

At 408, the one or more processors of computing device 104 may determine whether the second customer is the first customer based on the first information and the second information.

At 410, the one or more processors of computing device 104 may associate the first information related to identification of the first customer to the selected in-store service in response to the positive determination that the second customer is the first customer.

In some embodiments, in receiving the first information related to identification of the first customer, process 400 may receive the first information when the first customer provides a notification of an intention to visit the store.

In some embodiments, in receiving the first information related to identification of the first customer, process 400 may retrieve the first information from a database upon receiving a notification from the first customer of an intention to visit the store.

In some embodiments, the first information related to identification of the first customer may include a photograph of the first customer. Alternatively, the first information related to identification of the first customer may include a vehicle registration number of a vehicle associated with the first customer.

In some embodiments, the second information related to identification of the second customer may include a photograph of the second customer. Alternatively, the second information related to identification of the second customer may include a vehicle registration number of a vehicle associated with the second customer.

In some embodiments, the first information related to identification of the first customer and the second information related to identification of the second customer may be of a same type. For example, if a photograph of the first customer is used then a photograph of the second customer is used in the comparison. Likewise, if a vehicle registration number of a vehicle associated with the first customer is used then a vehicle registration number of a vehicle associated with the second customer is also used.

In some embodiments, process 400 may also include providing the first information related to identification of the first customer to one or more computing devices in the store in response to a positive determination that the second customer is the first customer.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. A method of recognition of in-store customers, the method comprising:
receiving, by one or more processors of a first computing device, first information related to identification of a first customer prior to the first customer visiting a store;
receiving, by the one or more processors, second information related to identification of a second customer when the second customer visits the store;
determining, by the one or more processors, whether the second customer is the first customer based on the first information and the second information; and
providing, by the one or more processors, the first information related to identification of the first customer to one or more second computing devices in response to a positive determination that the second customer is the first customer.

2. The method of claim 1, wherein the receiving the first information related to identification of the first customer comprises receiving the first information when the first customer provides a notification of an intention to visit the store.

3. The method of claim 1, wherein the receiving the first information related to identification of the first customer comprises retrieving the first information from a database upon receiving a notification from the first customer of an intention to visit the store.

4. The method of claim 1, wherein the first information related to identification of the first customer comprises a photograph of the first customer or a vehicle registration number of a vehicle associated with the first customer.

5. The method of claim 1, wherein the second information related to identification of the second customer comprises a photograph of the second customer or a vehicle registration number of a vehicle associated with the second customer.

6. The method of claim 1, wherein the first information related to identification of the first customer and the second information related to identification of the second customer are of a same type.

7. The method of claim 1, further comprising:
receiving, from the first customer, an indication of a selected in-store service; and
associating the first information related to identification of the first customer to the selected in-store service in response to the positive determination that the second customer is the first customer.

8. One or more computer-readable media storing computer-executable instructions that, when executed on one or more processors, causes the one or more processors to perform operations comprising:
receiving first information related to identification of a first customer prior to the first customer visiting a store;
receiving, from the first customer, an indication of a selected in-store service;
receiving second information related to identification of a second customer when the second customer visits the store;
determining whether the second customer is the first customer based on the first information and the second information; and
associating the first information related to identification of the first customer to the selected in-store service in response to the positive determination that the second customer is the first customer.

9. The one or more computer-readable media of claim 8, wherein the receiving the first information related to identification of the first customer comprises receiving the first information when the first customer provides a notification of an intention to visit the store.

10. The one or more computer-readable media of claim 8, wherein the receiving the first information related to identification of the first customer comprises retrieving the first information from a database upon receiving a notification from the first customer of an intention to visit the store.

11. The one or more computer-readable media of claim 8, wherein the first information related to identification of the first customer comprises a photograph of the first customer or a vehicle registration number of a vehicle associated with the first customer.

12. The one or more computer-readable media of claim 8, wherein the second information related to identification of the second customer comprises a photograph of the second customer or a vehicle registration number of a vehicle associated with the second customer.

13. The one or more computer-readable media of claim 8, wherein the first information related to identification of the first customer and the second information related to identification of the second customer are of a same type.

14. The one or more computer-readable media of claim 8, further comprising:
providing the first information related to identification of the first customer to one or more computing devices in the store in response to a positive determination that the second customer is the first customer.

15. An apparatus comprising:
a memory configured to store data and one or more sets of instructions; and
one or more processors coupled to the memory, the one or more processors configured to execute the one or more sets of instructions and perform operations comprising:
receiving first information related to identification of a first customer prior to the first customer visiting a store;
receiving second information related to identification of a second customer when the second customer visits the store;
comparing the first information and the second information to determine whether the second customer is the first customer; and
providing the first information related to identification of the first customer to one or more computing devices in response to a positive determination that the second customer is the first customer.

16. The apparatus of claim 15, wherein the receiving the first information related to identification of the first customer comprises receiving the first information when the first customer provides a notification of an intention to visit the store.

17. The apparatus of claim 15, wherein the receiving the first information related to identification of the first customer comprises retrieving the first information from a database upon receiving a notification from the first customer of an intention to visit the store.

18. The apparatus of claim 15, wherein the first information related to identification of the first customer comprises a photograph of the first customer or a vehicle registration number of a vehicle associated with the first customer.

19. The apparatus of claim 15, wherein the first information related to identification of the first customer and the second information related to identification of the second customer are of a same type.

20. The apparatus of claim 15, wherein the one or more processors are configured to further perform operations comprising:
receiving, from the first customer, an indication of a selected in-store service; and
associating the first information related to identification of the first customer to the selected in-store service in response to the positive determination that the second customer is the first customer.
